(19) United States
(12) Patent Application Publication
(10) Pub. No.: US 2025/0373000 A1
(43) Pub. Date: Dec. 4, 2025

(54) ELECTRICAL FUSE CONTROL CIRCUIT

(71) Applicant: TEXAS INSTRUMENTS INCORPORATED, DALLAS, TX (US)

(72) Inventors: Vatsal PATEL, AHMEDBAD (IN); Rampal BARJATI, SIKAR (IN); Subrato ROY, BANGALORE (IN); Dilip JAIN, BANGALORE (IN); Surya MISHRA, BANGALORE (IN); Karthikeya Kodur, Bangalore (IN)

(21) Appl. No.: 19/030,708

(22) Filed: Jan. 17, 2025

(30) Foreign Application Priority Data
Jun. 4, 2024 (IN) 202441043173

(51) Int. Cl. H02H 3/08; H02H 1/00; H02H 3/36

(52) U.S. Cl. CPC H02H 3/08; H02H 1/0007; H02H 3/365

(57) ABSTRACT

A described example includes a circuit. The circuit can include a current sense circuit having a sense input and a sense output, in which the sense input is coupled to an input terminal. A comparator has a first comparator input, a second comparator input, and a comparator output, in which the first comparator input is coupled to the sense output, the second comparator input is coupled to a threshold terminal, and the comparator output is coupled to a fuse terminal. A current programming circuit has a current input and a current output, in which the current input is coupled to the sense output. A first circuit is coupled between the sense output and a ground terminal. A second circuit is coupled between the current output and the ground terminal.

### CROSS-REFERENCE TO RELATED APPLICATION

This application claims priority to Indian Provisional Patent Application Ser. No. 202441043173, filed 4 Jun. 2024, which is incorporated herein by reference in its entirety.

### TECHNICAL FIELD

This description relates generally to a control circuit for an electrical fuse.

### BACKGROUND

Melting-wire fuses (also referred to as fuses) have been used in many applications to protect electrical circuits and loads from experiencing fault conditions, including short circuit and/or open load conditions. While melting-wires fuses can function within expected operating parameters, such fuses are physically replaced after being tripped and typically are located in fuse boxes at one or more accessible locations. Accordingly, there are trends to implement resettable electronic fuses (also referred to as electronic fuses or e-fuses) that include semiconductor switches that can be integrated into power paths to protect circuits during transient conditions.

### SUMMARY

One example includes a circuit. The circuit can include a current sense circuit having a sense input and a sense output, in which the sense input is coupled to an input terminal. A comparator has a first comparator input, a second comparator input, and a comparator output, in which the first comparator input is coupled to the sense output, the second comparator input is coupled to a threshold terminal, and the comparator output is coupled to a fuse terminal. A current programming circuit has a current input and a current output, in which the current input is coupled to the sense output. A first circuit is coupled between the sense output and a ground terminal. A second circuit is coupled between the current output and the ground terminal.

Another example described herein relates to a circuit. The circuit includes a current sense circuit configured to provide a first current signal representative of a square of a load current. A nominal current programming circuit is configured to provide a second current signal representative of a square of a nominal current for a simulated fuse, in which the current programming circuit is configured to set the square of the nominal current. A time-current circuit is configured to provide a voltage based on the first current signal and the second current signal. The time-current circuit can have an electrical characteristic representative of a current squared times time (I²t) rating for the simulated fuse based on the first current signal and the second current signal. A comparator is configured to provide a comparator output signal, defining a fault condition, based on a voltage across the time-current circuit relative to a threshold voltage.

Another example described herein relates to a system. The system includes a switch, defining a fuse, including a first current terminal, a second current terminal, and a control terminal, in which the first current terminal is coupled to a supply voltage terminal, and the second current terminal is coupled to a load terminal, and the supply voltage terminal and the load terminal are in a power path. A fuse control circuit includes a current sense circuit including a sense input and a sense output, in which the sense input is coupled to one of the first current terminal or the second current terminal. A multiplier circuit includes a multiplier input and a multiplier output, in which the multiplier input is coupled to the sense output. A comparator circuit includes a first comparator input, a second comparator input, and a comparator output, in which the first comparator input is coupled to the multiplier output, the second comparator input is coupled to a threshold terminal, and the comparator output is coupled to the control terminal of the transistor. A current programming circuit includes a current input and a current output, in which the current input is coupled to the multiplier output. A capacitor is coupled between the multiplier output and a ground terminal.

### BRIEF DESCRIPTION OF THE DRAWINGS

FIG. 1 is a block diagram illustrating an example system to control an e-fuse.

FIG. 2 is a block diagram illustrating another example system to control an e-fuse.

FIG. 3 is a block diagram illustrating yet another example system to control an e-fuse.

FIG. 4 is a circuit diagram illustrating an example e-fuse control circuit.

FIG. 5 is a graph illustrating example e-fuse characteristics that can be implemented by an e-fuse control circuit.

FIG. 6 is a signal diagram illustrating examples of signals in the system of FIG. 4.

FIG. 7 is a signal diagram illustrating example transient responses for a first voltage condition of the e-fuse control circuit of FIG. 4.

FIG. 8 is a signal diagram illustrating example transient responses for a second voltage condition of the e-fuse control circuit of FIG. 4.

FIG. 9 is a graph showing examples of I²t characteristics for an e-fuse control circuit configured for different nominal currents.

FIG. 10 is a graph showing examples of It characteristics for melting fuses having different nominal currents.

FIG. 11 is a block diagram of an example power distribution system that includes e-fuse control circuits.

### DETAILED DESCRIPTION

This description relates generally to control circuits and systems to control electronic fuses (also referred herein to as e-fuses or smart fuses).

As an example, a circuit is configured to control an e-fuse, such as by emulating current timing characteristics (e.g., current squared times time (I²t) characteristics) of a melting (e.g., wire) fuse (also referred to herein as a fuse). The melting fuse can also include a nominal current rating (referred to as I_NOM), below which the given fuse does not melt and normal operation of the circuit can occur uninterrupted. The I²t rating of a given fuse represents overcurrent timing characteristics in Amperes²*s (A²s) for the given fuse to shut down (e.g., a melting point) responsive to load current through the fuse that exceeds I_NOM.

As described herein, the circuit includes a current sense circuit configured to provide a first current signal representative of a square of a load current I_LOAD. For example, the load current I_LOAD can be provided through an e-fuse in a power path to a load. A current programming circuit is configured to provide a second current signal representative of a square of I_NOM for a simulated fuse. The nominal current programming circuit can be configured to set the square of I_NOM, such as by setting an impedance value (e.g., a resistance or other impedance) of the current programming circuit. A time-current circuit is configured to provide a voltage based on the first current signal and the second current signal. For example, the voltage provided by the time-current circuit has an electrical characteristic representative of the I²t rating for the simulated fuse based on the first current signal and the second current signal. The time-current circuit can be configured to set the I²t rating for the simulated fuse, such as by setting an impedance value (e.g., a capacitance) of the time-current circuit. The circuit can also include a comparator configured to provide a comparator output signal, defining a fault condition, based on a voltage across the time-current circuit relative to a threshold voltage. The comparator output signal can be provided to open an e-fuse (e.g., a resettable switch, such as a transistor). The e-fuse thus can be configured to open responsive to the comparator output signal so as to exhibit I²t characteristics of the simulated fuse. As used herein, a simulated fuse refers to current and current timing characteristics (e.g., fuse ratings) that the control circuit 102 is configured to implement for controlling the e-fuse 104 to emulate the profile of a corresponding melting fuse.

The circuits and systems described herein thus can be configured to control I²t and current characteristics for controlling an e-fuse to emulate the profile of a desired melting fuse. Unlike traditional melting fuses, e-fuses are resettable electronically and therefore the fuses do not need to easily be accessible (e.g., in fuse boxes or panels). Because e-fuses do not need to be easily accessible the length of cables can be reduced for many power distribution systems compared to those implementing traditional melting fuses. Also, or as an alternative, the gauge of many cables may be reduced compared to approaches that use traditional fuses. Accordingly, the circuits and systems described herein can be implemented to reduce the overall cost of many power distribution systems.

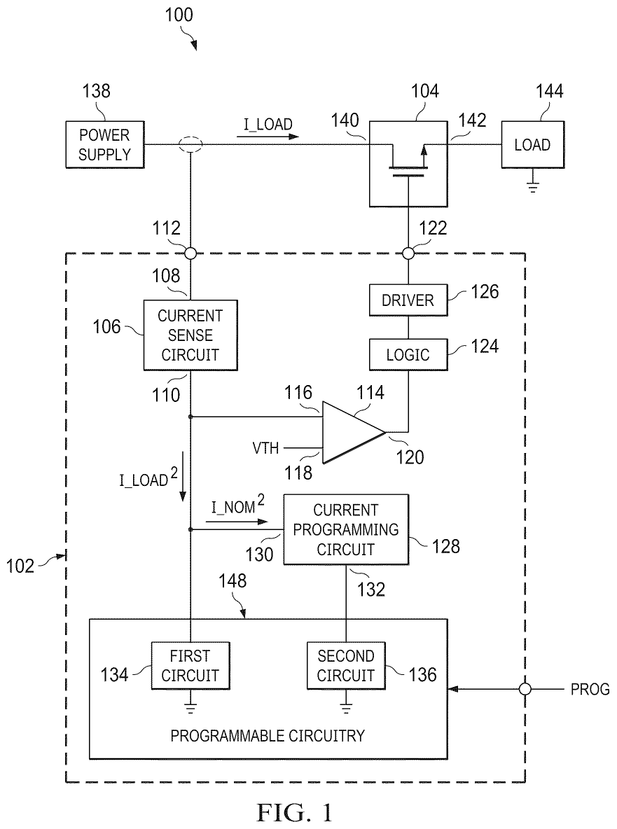

FIG. 1 is a block diagram illustrating an example system 100 that includes a control circuit (e.g., also referred to as an e-fuse control circuit) 102 that can be implemented to control an e-fuse 104. The control circuit 102 includes a current sense circuit 106 having a sense input 108 and a sense output 110. The sense input can be coupled to an input terminal 112 (e.g., a terminal of an integrated circuit (IC) that includes the control circuit 102). In the example of FIG. 1, the current sense circuit 106 is shown as part of the control circuit 102. In other examples, some or all components of the current sense circuit 106 could be implemented externally to the control circuit 102.

The control circuit 102 includes a comparator 114 having a first comparator input 116, a second comparator input 118, and a comparator output 120. The first comparator input 116 is coupled to the sense output 110, and the second comparator input 118 is coupled to a threshold terminal to receive a threshold signal (e.g., a threshold voltage, shown as VTH). The comparator output 120 is coupled to a fuse terminal 122 (e.g., another terminal of the IC that includes the control circuit 102). In the example of FIG. 1, logic 124 and driver 126 are coupled in series between the comparator output 120 and the fuse terminal 122. In other examples, the comparator output can be coupled directly to the fuse terminal or through one or more other components. A control input of the e-fuse 104 can be coupled to the fuse terminal, such that an output signal from the comparator 114 can control the e-fuse.

A current programming circuit 128 has a current input 130 and a current output 132, in which the current input 130 is coupled to the sense output 110. In the example of FIG. 1, the control circuit 102 includes first and second circuits 134 and 136, respectively. The first circuit 134 is coupled between the sense output 110 of the current sense circuit 106 and a ground terminal, and the second circuit 136 is coupled between the current output 132 of the current programming circuit 128 and the ground terminal. Various circuit elements, including passive and active elements (e.g., transistors) can be used to implement each of the first and second circuits 134 and 136 to provide desired current timing characteristics.

In the example of FIG. 1, a power supply (e.g., a battery or other power source) 138 is coupled to a first terminal 140 of the e-fuse 104, and second terminal 142 of the e-fuse is coupled to a load 144. The power supply 138 is configured to provide a load current I_LOAD to the load 144 through a power path (e.g., of a power distribution system) that includes the e-fuse 104. In an example, the e-fuse 104 is a transistor such as a field effect transistor (FET) coupled in the power path between the power supply 138 and the load 144 and having a gate coupled to the fuse terminal 122. The input terminal 112, to which the sense input 108 is coupled, is coupled to the first terminal 140 of the e-fuse 104. For example, a current sense resistor or other circuit can be coupled in a power path between the output of the power supply and the input of the e-fuse and configured to provide a signal representative of the load current I_LOAD to current sense circuit 106.

The current sense circuit 106 can be configured to provide a first current signal at the sense output 110 that is proportional to a square of the sensed load current signal (I_LOAD²). The current programming circuit 128 is configured to provide a second current signal at the current input 130, which is representative of a square of the nominal current (I_NOM²) for a simulated fuse. I_NOM² also defines a sink current provided to the current input 130 and to the current output 132.

In one example, the first circuit 134 and the second circuit 136 include circuit components configured to define current and current timing characteristics to be implemented for controlling the e-fuse 104 to emulate a simulated fuse with such current timing characteristics. For example, the second circuit 136 is configured to set a value of I_NOM², and the first circuit 134 is configured to set a value representative of an I²t profile for a simulated fuse based on the current signals I_LOAD² and I_NOM².

As a further example, one or both of the first circuit 134 and the second circuit 136 include programmable circuitry 148, such that the first and/or second circuits can be configured to define current and current timing characteristics for the e-fuse 104 responsive to a program signal, shown as PROG. In an example, the first circuit 134 (e.g., variable capacitor network) has a programmable capacitance that is set responsive to the PROG signal. Also, or as an alternative, the second circuit 136 (e.g., a variable resistor network, such as a transistor network or other resistive element) has a programmable resistance that is set responsive to the PROG signal. Other electrical characteristics can be programmable in the first circuit 134 and/or the second circuit 136 responsive to the PROG signal. In an example, the PROG signal is provided at a program input terminal 146 of an IC that includes the control circuit 102, including the programmable circuitry 148. For example, the PROG signal can be set in a register (or other memory device), by setting configuration fuses of the IC, or the other methods. In other examples, one or both of the first circuit 134 and the second circuit 136 can be implemented by one or more discrete components (e.g., capacitors and resistive elements) configured to provide desired electrical characteristics.

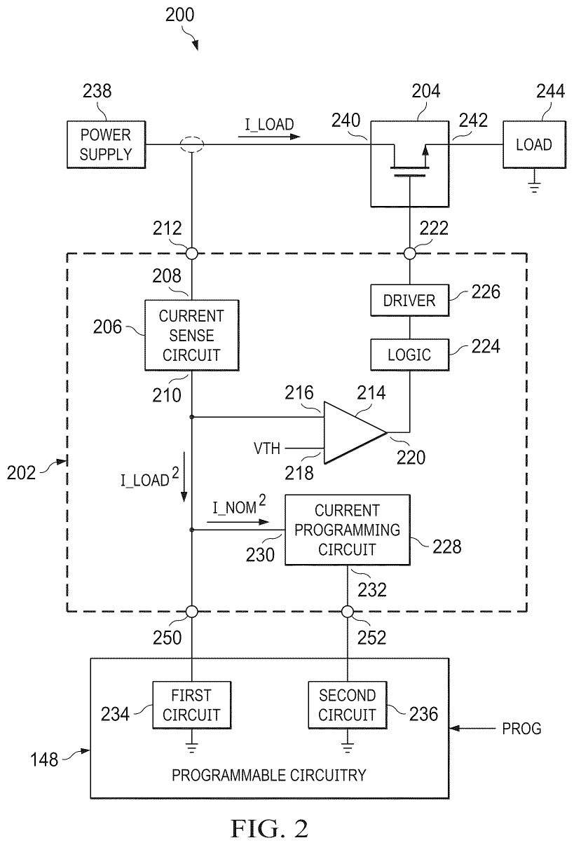

FIG. 2 is a block diagram illustrating another example system 200 that includes a control circuit 202 configured to control an e-fuse 204. The example system 200 in FIG. 2 is identical to the system 100 of FIG. 1, except that the programmable circuitry 248, is external to an IC that includes the control circuit 202. For ease of explanation, FIG. 2 uses the same reference numbers, increased by adding one-hundred (100), to describe respective features and components introduced in FIG. 1. Accordingly, the description of FIG. 2 can also refer to certain aspects of FIG. 1.

Briefly stated, the control circuit 202 includes a current sense circuit 206 having a sense input 208 and a sense output 210. The sense input can be coupled to an input terminal 212 (e.g., a terminal of an integrated circuit (IC) that includes the control circuit 202). The control circuit 202 also includes a comparator 214 having a first comparator input 216, a second comparator input 218, and a comparator output 220. The first comparator input 216 is coupled to the sense output 210, the second comparator input 218 is coupled to a threshold terminal to receive a threshold signal (VTH). The comparator output 220 is coupled to a fuse terminal 222 of the IC that includes the control circuit 202. In the example of FIG. 2, logic 224 and a driver 226 are coupled between the comparator output 220 and the fuse terminal 222. The e-fuse 204 has respective terminals 240 and 242, in which the terminal 240 is coupled to an output of power supply 238, and terminal 242 is coupled to the load 244. A control terminal of the e-fuse 204 can be coupled to the fuse terminal 222, such that an output signal from the comparator 214 can control the e-fuse, as described herein.

A current programming circuit 228 has a current input 230 and a current output 232, in which the current input 230 is coupled to the sense output 210. In the example of FIG. 2, first and second circuits 234 and 236 are coupled between respective terminals 250 and 252 and a ground terminal. Thus, the first and second circuits 234 and 236 are implemented externally with respect to an IC that includes the control circuit 202. Regardless of their location, the first and second circuits 234 and 236 can be considered part of the control circuit 202.

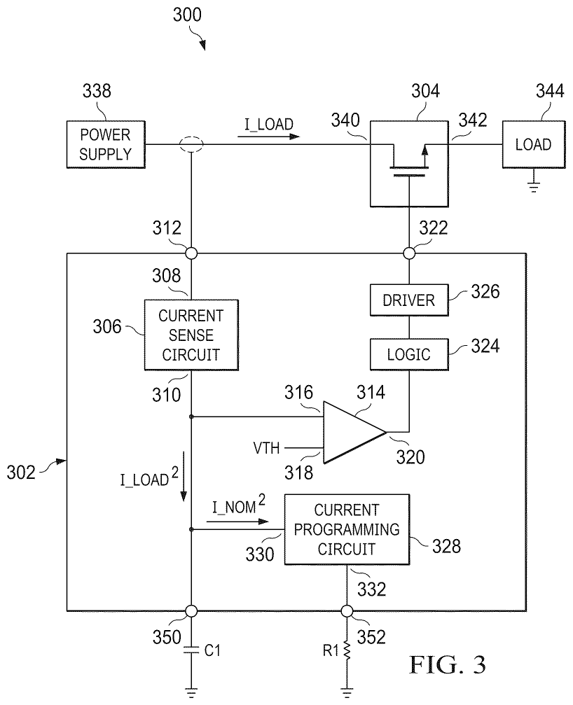

FIG. 3 is a block diagram illustrating another example system 300 that includes a control circuit 302 configured to control an e-fuse 304. The example system 300 in FIG. 3 is identical to the system 200 of FIG. 2, except that the first and second circuits 234 and 236 of FIG. 2 are implemented as respective passive components, in which the first circuit is a capacitor C1 and the second circuit is a resistor R1. As used herein, the term resistor can refer to a discrete resistor, a network of resistors, a network of FETs, or other resistive element configured to provide electrical resistance. Like the example of FIGS. 2, C1 and R1 are shown as external to an IC that includes the control circuit 302. Specifically, C1 is coupled between a terminal 350 and a ground terminal and R1 is coupled between another terminal and the ground terminal. In other examples, one of or both C1 and R1 could be implemented within the IC that includes the control circuit 302. Regardless of their location, C1 and R1 can be considered part of the control circuit 302. For ease of explanation, FIG. 3 uses the same reference numbers, increased by adding one-hundred (100), to describe respective features and components introduced in FIG. 2. Accordingly, the description of FIG. 3 can also refer to certain aspects of FIG. 2 as well as FIG. 1.

Briefly stated, the control circuit 302 includes a current sense circuit 306 having a sense input 308 and a sense output 310. The sense input can be coupled to an input terminal 312 (e.g., a terminal of an integrated circuit (IC) that includes the control circuit 302). The control circuit 302 also includes a comparator 314 having a first comparator input 316, a second comparator input 318, and a comparator output 320. The first comparator input 316 is coupled to the sense output 310, the second comparator input 318 is coupled to a threshold terminal to receive a threshold signal (VTH). The comparator output 320 is coupled to a fuse terminal 322 of the IC that includes the control circuit 302. In the example of FIG. 3, logic 324 and a driver 326 are coupled between the comparator output 320 and the fuse terminal 322. A control terminal of the e-fuse 304 can be coupled to the fuse terminal 322, such that an output signal from the comparator 314 can control the e-fuse, as described herein. The e-fuse also has terminals 340 and 342, in which terminal 340 is coupled to an output of the power supply 338 and terminal 342 is coupled to a load 344. A current programming circuit 328 has a current input 330 and a current output 332, in which the current input 330 is coupled to the sense output 310 and the current output is coupled to the terminal 352.

As described herein, R1 is coupled to terminal 352 and configured to set I_NOM² to simulate operation of a fuse. Similarly, C1 is coupled to terminal 350 and configured to set a value representative of an I²t profile for the simulated fuse based on current signals I_LOAD² and I_NOM². For example, a resistance value for R1 can be selected to set a desired nominal overcurrent I_NOM for a simulated fuse. A capacitance value for C1 likewise can be selected to set a desired I²t characteristic for the simulated fuse. By selectively configuring the values of C1 and R1, the control circuit 302 can control the e-fuse (e.g., a transistor) 304 to operate with desired current and current timing characteristics for virtually any simulated fuse. In some examples, a data sheet, equations, or other resources can be provided to enable users to determine appropriate values of the C1 and R1 to achieve desired operating parameters (e.g., current and current timing characteristics) for the control circuit 302 to control the e-fuse 304.

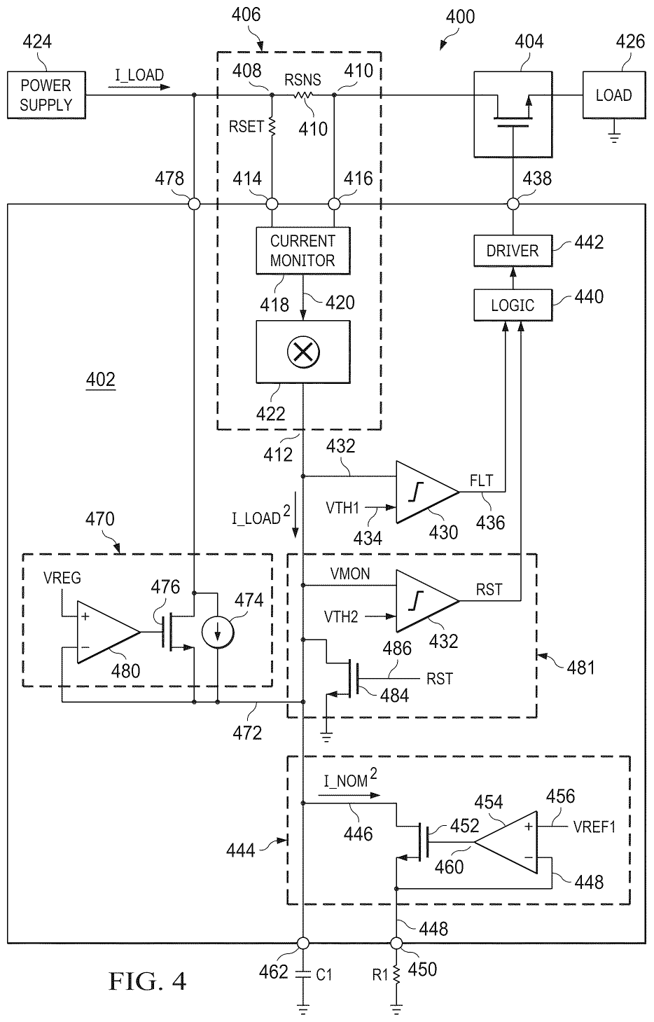

FIG. 4 is a circuit diagram for a circuit 400 that includes an example e-fuse control circuit (also referred to as a control circuit) 402. The circuit 400 can be used to implement the system 100, 200, or 300 of any of FIGS. 1, 2, and/or 3. Accordingly, the description of FIG. 4 may also refer to certain aspects of FIGS. 1, 2, and 3.

As described herein, the control circuit 402 is configured to control an e-fuse 404 responsive to a load current I_LOAD to emulate the profile of a simulated fuse having defined current timing characteristics. The control circuit 402 includes a current sense circuit 406 having terminals 408 and 410 and a sense output 412. In the example of FIG. 4, the current sense circuit 406 includes a sense resistor RSNS coupled between terminals 408 and 410 and a set resistor RSET coupled between the terminal 408 and a terminal 414 of an IC that includes the control circuit 402. The terminal 410 can be coupled to another terminal 416 of the IC. A current monitor 418 has inputs coupled to the terminals 414 and 416 and an output 420 coupled to an input of a multiplier 422, and the multiplier has an output coupled to the sense output 412 of the current sense circuit 406.

In the example of FIG. 4, a power supply 424 has an output coupled to a power path to which one or more loads 426 are coupled. The power supply 424 is configured to provide power (e.g., voltage and current) to the load 426 through the power path between the power supply and the load. The load 426 thus receives a load current I_LOAD through the power path, which includes the sense resistor RSNS and the e-fuse 404.

As described herein, the current sense circuit 406 is configured to sense the load current I_LOAD that flows through the sense resistor RSNS and provide a signal at the sense output 412 based on the sensed load current I_LOAD. For example, the current monitor 418 includes an amplifier (e.g., a chopper amplifier) having inputs coupled to the terminals 414 and 416, in which the amplifier is configured to regulate a sensed voltage (V_SENSE) across the set resistor RSET. The sensed voltage across RSET thus can be equal to (or approximate) the voltage drop across RSNS (e.g., V_SENSE=RSNS*I_LOAD). The current monitor 418 provides an output signal at the output 420 representative of (e.g., proportional to) the load current I_LOAD. A multiplier 422 has an input coupled to the output 420 and an output coupled to the sense output 412 of the current sense circuit 406. The multiplier 422 can include a translinear circuit configured to provide current to the sense output 412 based on an output signal at the output 420 that is proportional to the square of the current provided at 420 (e.g., by the current monitor).

The control circuit 402 also includes a comparator 430 having comparator inputs 432 and 434 and a comparator output 436. The comparator input 432 is coupled to the sense output 412 and the other comparator input 434 is coupled to a threshold terminal. The sense output 412 can provide a monitored voltage VMON that is representative of (e.g., equal to) the voltage at terminal 462 (e.g., the voltage across C1). For example, the threshold terminal can be coupled to an output of DC voltage source (e.g., a regulated voltage) configured to provide a threshold voltage VTH1, which can be set to define a threshold voltage for detecting a fault condition responsive to the load current I_LOAD exceeding a current limit. The comparator output 436 can be coupled to a fuse terminal 438. For example, the comparator output 436 is coupled to the fuse terminal 438 through logic and driver 440 and 442. For example, the comparator 430 is configured to provide a fault signal (FLT) at the comparator output 436 responsive to the voltage at the comparator input 432 exceeding the threshold voltage VTH1. The logic and driver 440 and 442 are configured to provide a fuse control signal at the fuse terminal 438 responsive to the fault signal FLT indicating a fault condition. For example, the e-fuse can be turned off (e.g., to provide an open circuit) along the power path responsive to the FLT signal indicating the fault condition.

The control circuit 402 also includes a current programming circuit 444 having a current input 446 and a current output 448, in which the current input 446 is coupled to the sense output 412. The current output 448 is coupled to a terminal 450 of the IC that includes the control circuit 402. In the example of FIG. 4, the current programming circuit 444 is a voltage-to-current converter that includes a transistor 452 and an amplifier 454. The transistor 452 (e.g., a FET) includes a first current terminal (e.g., drain), a second current terminal (e.g., source), and a control terminal (e.g., gate), in which the first current terminal is coupled to the sense output 412, and the second current terminal is coupled to the terminal 450. The amplifier 454 includes amplifier inputs 456 and 458 and an amplifier output 460, in which the amplifier input (e.g., a non-inverting input) 456 is coupled to a voltage reference terminal (e.g., receives a reference voltage VREF1) and the other amplifier input (e.g., an inverting input) 458 is coupled to the second current terminal (e.g., source) of the transistor 452. The amplifier output 460 is coupled to the control terminal (e.g., gate) of the transistor 452. A resistor R1 is coupled between the terminal 450 and a ground terminal. The transistor 452 and amplifier 454 of the current programming circuit 444 are configured to regulate the voltage at the terminal 450 to the reference voltage VREF1, which provides (e.g., sinks) a current I_NOM² at the current input 446. The values of VREF1 and R1 can be configured to set a current I_NOM² responsive to operation of the current programming circuit 444.

A capacitor C1 is coupled between the ground terminal and another terminal 462 of the IC that includes the control circuit 402. The current input 446 of the current programming circuit 444 and the sense output 412 of the current sense circuit 406 are also coupled to the terminal 462. The value of C1 can be set to a capacitance to configure I²t timing characteristics implemented by the control circuit during an overcurrent event. As a further example, the monitored voltage VMON represents the voltage across C1, which is proportional to I_LOAD²−I_NOM². While C1 and R1 are shown as external components in the example of FIG. 4, such components can be implemented internal to the control circuit IC or as otherwise provided herein (see, e.g., FIGS. 1, 2, and 3).

As shown in FIG. 4, the control circuit 402 can include additional circuitry to help enable the circuit to operate in practical use environments. As an example, the control circuit 402 includes a regulator circuit 470 having a regulator output 472 coupled to the sense output 412 of the current sense circuit 406, which is also coupled to the comparator input 432. In the example of FIG. 4, the regulator circuit 470 may include a current source 474 coupled in parallel with a transistor 476 between a power terminal 478 and the regulator output 472. The current source 474 can be configured to provide current to facilitate charging of the capacitor C1 at an increased rate. The power terminal 478 can be coupled to the output of the power supply 424 (or to another power source). An amplifier (e.g., an operational amplifier) 480 has an input (e.g., a non-inverting input) coupled to a voltage terminal to receive DC voltage, shown as VREG. Another input (e.g., an inverting input) of the amplifier 480 is coupled to the regulator output. An output of the amplifier 480 is coupled to a control terminal of the transistor 476. The regulator circuit 470 is configured to provide a regulated voltage at the sense output 412 for normal operating conditions, including when there is no overcurrent event (e.g., I_LOAD is less than the overcurrent current limit I_NOM). The current source 474 can be configured to provide a current signal to facilitate charging the capacitor C1. Other configurations of voltage regulator circuits can be used as the regulator circuit 470 in other examples.

The control circuit 402 can also include a reset circuit 481, which in the example of FIG. 4 includes a comparator 482 and a switch 484. The comparator 482 includes first and second reset inputs and a reset output, in which the first reset input is coupled to the sense output 412, and the second reset input is coupled to a threshold voltage terminal to receive a threshold voltage, shown as VTH2. The output of the comparator 482 can be coupled to the logic 440, which can be coupled to a control terminal 486 of the switch 484 directly or through other circuitry (e.g., a driver—not shown). In other examples, the output of the comparator 482 can be coupled to the control terminal 486 of the switch 484. The comparator 482 thus can be configured to control the switch 484 to discharge the capacitor C1 and bring the voltage across the capacitor C1 (e.g., the voltage at terminal 462, namely, VMON) closer to a desired value faster and independent of the closed loop operation of the voltage regulator 470. In an example, the switch 484 is a transistor (e.g., a FET) including a first current terminal (e.g., drain), a second current terminal (e.g., source), and a control terminal (e.g., gain). The first current terminal can be coupled to the sense output 412, and the second current terminal can be coupled to the ground terminal. The comparator 482 is configured to provide a reset control signal RST based on the voltage at the sense output 412 relative to VTH2. For example, VTH2 can be less than the regulated voltage VREG. The switch 484 can be configured to control discharging of the capacitor C1 based on the output of the comparator 482. For example, the switch 484 can be coupled between terminal 462 (also coupled to the sense output 412) and ground. The switch 484 thus can be configured to discharge the voltage at 462, also defining the voltage across C1, responsive to the comparator 430 detecting a fault condition. The logic 440 can be configured to provide such discharging until the comparator 482 detects the voltage at the current sense output 412 reaches VTH2, at which the comparator 482 provides the RST signal and the discharging can be terminated by the logic 440 (or other circuitry) turning off the switch 484. The regulator circuit 470 then is configured to charge the voltage across C1 back to the regulated voltage VREG until a next overcurrent event occurs. In an example, the logic 440 can be configured to control the switch 484 (for discharging C1) and current source 474 (for charging C1) in a complementary manner, such as responsive to the outputs of the respective comparators 430 and 482. For example, the switch 484 is turned on to trigger discharging of C1 responsive to the FLT signal at 436 and occurs until the falling edge of the RST signal, at which the discharge path (e.g., switch 484) is turned off. The current source 474 can be activated to provide fast charging of C1 at the falling edge of RST, and the current source can be turned off at the rising edge of the RST signal, at which the regulator circuit 470 takes VMON to VREG.

As described herein, the control circuit 402 includes analog circuitry configured to emulate an I²t profile of a simulated melting fuse and provide a fuse control signal at the fuse terminal 438 to control the e-fuse 404 with the emulated current timing characteristics (e.g., a fuse profile). The current timing characteristics being emulated by the control circuit 402 can be set (e.g., the timing characteristics are configurable) based on the values of one or more analog circuit components (e.g., the values of C1 and R1). For the example circuit 400 of FIG. 4, the overcurrent time TOC, which is used to simulate shutdown of a desired melting fuse, can be expressed as follows:

$$TOC = ( \frac{C 1}{{I\_LOAD}^{2} - {I\_NOM}^{2}} ) \times V TH 1$$

Because the current timing characteristics can be controlled by such analog circuitry, the control circuit 402 can emulate simulated fuses more accurately without being limited to step size as in digital solutions. Additionally, the analog circuitry is not susceptible to programming errors (e.g., to being erased) as can occur in digital circuitry during overcurrent and other transient events. Thus, a number of one or more instances of the control circuit 402 can be implemented on an IC with less complexity and correspondingly less die area than some existing digital solutions. The profile of the melting fuse being simulated by the control circuit 402 can be easily monitored (e.g., at the terminal 462) to confirm or validate the current timing characteristics.

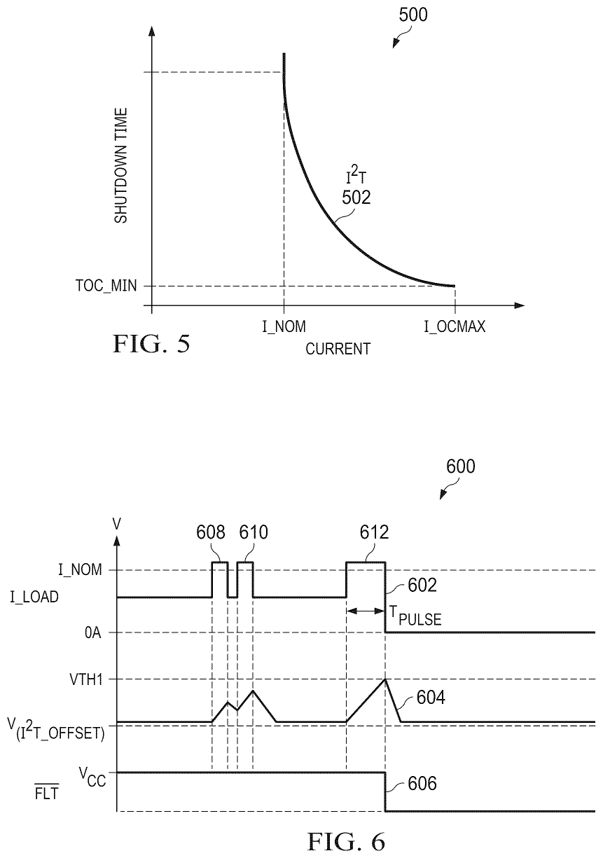

FIG. 5 is a graph 500 illustrating a curve 502 exhibiting example current timing characteristics of a simulated fuse that can be implemented by the systems and circuits described herein (e.g., system 100, 200, 300, 400). The curve 502 has a nominal current I_NOM that defines an overcurrent condition for a load current. For example, when I_LOAD<I_NOM there is no fault condition and normal operation of the power path can be provided. When I_LOAD>I_NOM then the FET turn-off function is implemented by the control circuit. The graph 500 also shows a maximum overcurrent I_OCMAX, which determines a minimum overcurrent time TOC_MIN for the simulated fuse. As described herein, the I²t current timing characteristics of the e-fuse being simulated can depend on the first circuit or C1 that is used for the control circuit. Also, the second circuit or R1 can be configured to define I_NOM² for the simulated fuse.

FIG. 6 is a signal diagram 600 showing examples of signals in the system of FIG. 4. Specifically, the signal diagram 600 includes an I_LOAD signal 602 (e.g., representative of current sensed by current sense circuit 406 along the power path. The signal diagram 600 also includes a monitored voltage (VMON) 604, which is representative of the voltage across at terminal 462 across C1. A FLT signal 606, which is representative of the signal at the comparator output 436 of the comparator 430. Responsive to an overcurrent event (e.g., I_LOAD>I_NOM), shown at current pulse 608, the voltage VMON increases responsive to C1 charging with current proportional to I_LOAD²−I_NOM². After the load current I_LOAD reduces to a level below I_NOM, VMON likewise decreases due to C1 discharging with current proportional to I_NOM²−I_LOAD², which further simulates an actual melting fuse. Responsive to a second overcurrent event, shown at current pulse 610, the voltage VMON increases further responsive to C1 charging with current proportional to I_LOAD²−I_NOM². However, the load current pulse ends before VMON exceeds the threshold voltage VTH1, such that no fault condition is triggered. Responsive to another overcurrent event, shown at current pulse 612, C1 charges with current proportional to I_LOAD²−I_NOM² and the voltage VMON increases to the threshold voltage. The pulse 612 has a pulse width shown as T_{PULSE}. Responsive to VMON reaching (or exceeding) VTH1, a fault condition is indicated and the FLT signal 606 goes low. After the fault condition is indicated, the switch 484 can be activated responsive to a reset control signal to discharge C1. Responsive to the voltage VMON reaching the other threshold voltage VTH2, the comparator 482 turns off the switch 484 and the regulator circuit 470 can provide current and regulated voltage at the terminal 462 to the regulated voltage VREG. Once the regulated voltage VREG is provided across C1, the control circuit is ready for a next overcurrent event.

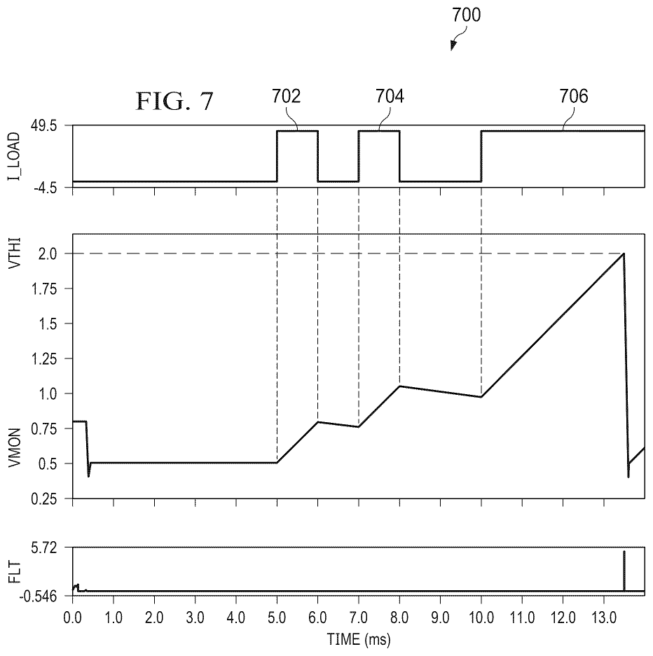

FIG. 7 is a signal diagram 700 for example transient responses that can be implemented by the control circuit 402 of FIG. 4. In the example of FIG. 7, the voltage VMON across C1 is initially charged to a voltage that exceeds VREG. Accordingly, the control circuit 402 is configured to discharge C1 to VTH2, which is less than VREG, and then the regulator circuit 470 is configured to provide the regulated voltage VREG at the terminal 462 and charge C1 to VREG.

The remaining signal conditions demonstrated in FIG. 7 are similar to as described with respect to FIG. 6. Responsive to an overcurrent event I_LOAD>I_NOM, shown at current pulse 702, the voltage VMON increases responsive to C1 charging with current proportional to I_LOAD²−I_NOM². After the load current I_LOAD reduces to a level below I_NOM, VMON likewise decreases due to C1 discharging with current proportional to I_NOM²−I_LOAD². Responsive to a next overcurrent event, shown at current pulse 704, the voltage VMON increases from the present voltage further responsive to C1 charging with current proportional to I_LOAD²−I_NOM². After the pulse 704, the voltage VMON decreases responsive to C1 discharging. However, VMON does not reduce back to its regulated voltage VREG. In another example, given enough time after the overcurrent event caused by the current pulse 704, VMON may discharge to VREG. As a result, responsive to another (longer duration) overcurrent condition, shown at current pulse 706, VMON increases from its present voltage responsive to C1 charging. Responsive to VMON reaching the threshold voltage VTH1, a fault condition is triggered at the FLT signal and C1 is discharged causing VMON to decrease rapidly.

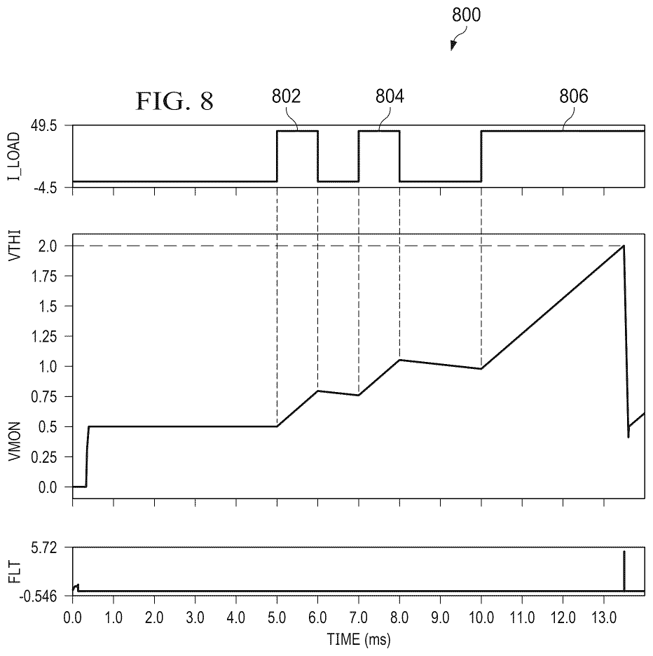

FIG. 8 is a graph illustrating example transient responses for another starting voltage condition of the e-fuse control circuit of FIG. 4. In the example of FIG. 8, the voltage VMON across C1 at 0 V. Accordingly, the regulator circuit 470 and current source 474 are configured to the charge capacitor C1, until voltage VMON at the terminal 462 reaches VTH2. Responsive to the voltage VMON reaching VTH2, the current source 474 (e.g., used for fast startup) can be turned off (e.g., by the logic circuit 440) and the regulator circuit 470 is configured to charge capacitor C1 to VREG and regulate the voltage VMON at terminal 462 to VREG. From this starting regulated voltage, the remaining signal conditions demonstrated in FIG. 8 are similar to those described with respect to FIG. 7. Briefly stated, responsive to an overcurrent event, shown at current pulse 802 of I_LOAD, the voltage VMON increases responsive to C1 charging. After the load current I_LOAD reduces, VMON likewise decreases due to C1 discharging (e.g., simulating cooling of a melting fuse). Responsive to a next overcurrent event, shown at current pulse 804, VMON increases responsive to C1 charging. After the current pulse 804, the voltage VMON can decrease responsive to C1 discharging. Another overcurrent condition, shown at current pulse 806, VMON increases and responsive to VMON reaching the threshold voltage VTH1, a fault condition is triggered at the FLT signal and C1 is discharged rapidly reducing VMON.

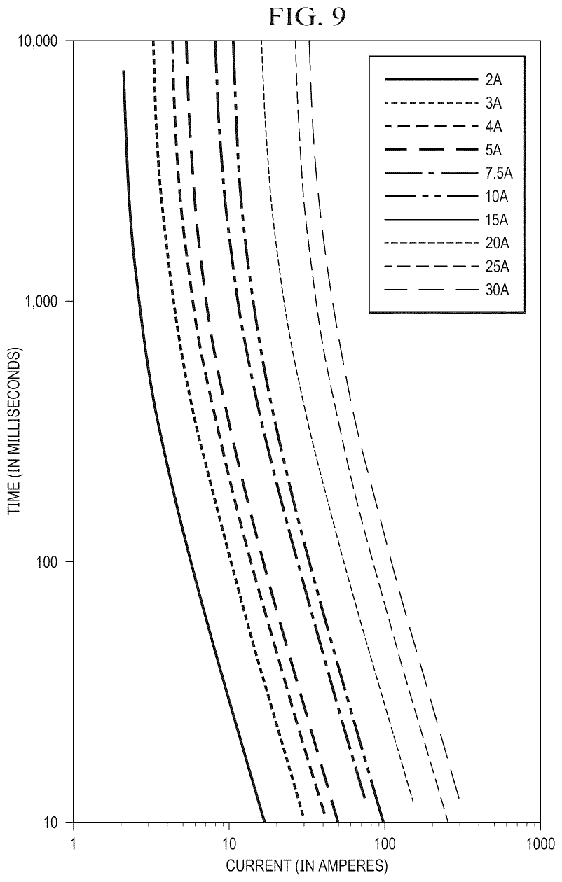

FIG. 9 is a graph showing examples of different I²t characteristics for different nominal currents which can be implemented by an e-fuse control circuit (e.g., control circuit 102, 202, 302, 402).

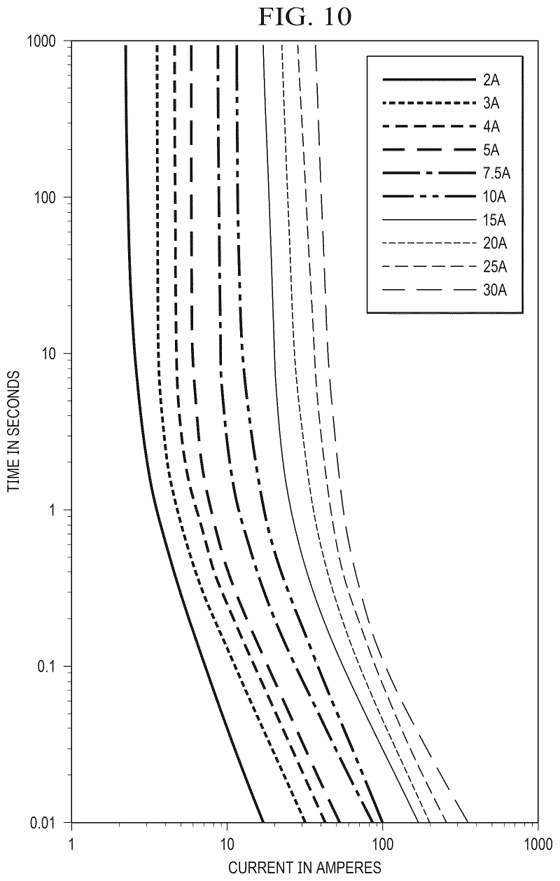

FIG. 10 is a graph showing examples of It characteristics for melting fuses having different nominal currents. A comparison of FIGS. 9 and 10 demonstrates that the control circuits can be configured to substantially match the I²t characteristics of actual melting fuses.

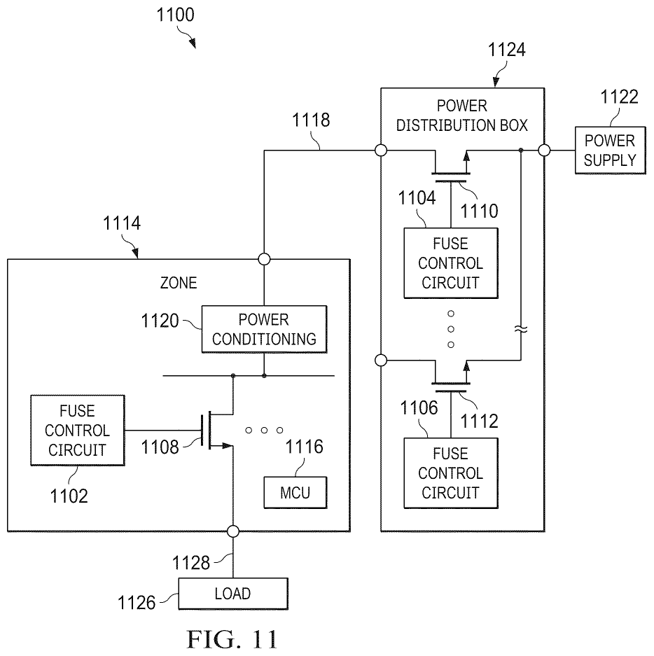

FIG. 11 is a block diagram of a power distribution system 1100 that includes a number of fuse control circuits 1102, 1104, and 1106. Each of the fuse control circuits 1102, 1104, and 1106 is coupled to a respective e-fuse 1108, 1110, and 1112. While three fuse control circuits 1102, 1104, and 1106 are shown in FIG. 11, there can be any number of control circuit-e-fuse pairs according to the number of fuses in the power distribution system (shown by ellipses). Each fuse control circuit 1102, 1104, and 1106 can be configured to emulate the same or different I²t characteristics depending on the profile of respective melting fuses being simulated by the respective control circuit.

In the example of FIG. 11, fuse control circuits 1102, 1104, and 1106 and respective e-fuses 1108, 1110, and 1112 can be distributed in different zones across the power distribution system 1100. For example, the fuse control circuit 1102 and associated e-fuse 1108 can be implemented in a zone 1114 associated with a controller (e.g., a microcontroller unit (MCU)) 1116. The zone 1114 can include any number and arrangement of control circuits and associated e-fuses. The zone 1114 which can be coupled to a power path 1118 through power conditioning circuitry 1120. A power supply 1122 can be coupled to the power path, such as through the e-fuse 1110. The fuse control circuits 1104 and 1106 and associated e-fuses 1110 and 1112 can be part of a power distribution box 1124, which can distribute power to any number of other circuits or loads. In a further example, a given load 1126 can be coupled to the zone 1114 by a connection 1128. In some examples, the connection 1128 can be a wire, particularly, a smaller gauge wire than the main power path 1118. In the example power distribution system 1100, it is evident that e-fuses (unlike traditional melting fuses) need not be easily accessible. Also, or as an alternative, in the power distribution system 1100, the cable (e.g., wiring) length from the power supply 1122 to the load can be reduced because a central fuse box is not required.

In this description, numerical designations “first”, “second”, etc. are not necessarily consistent with same designations in the claims herein and these numerical designations are used to simply distinguish one element from another.

Additionally, the term “couple” or variants thereof may cover connections, communications, or signal paths that enable a functional relationship consistent with this description. For example, if device A generates a signal to control device B to perform an action, then: (a) in a first example, device A is directly coupled to device B; or (b) in a second example, device A is indirectly coupled to device B through intervening component C if intervening component C does not alter the functional relationship between device A and device B, so device B is controlled by device A via the control signal generated by device A.

In this description, the term “based on” means based at least in part on. Also, in this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Furthermore, a circuit or device described herein as including certain components may instead be configured to couple to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor wafer and/or integrated circuit (IC) package) and may be configured to couple to at least some of the passive elements and/or the sources to form the described structure, either at a time of manufacture or after a time of manufacture, such as by an end user and/or a third party.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means within +/−20 percent of the stated value, or, if the value is zero, a reasonable range of values around zero.

Modifications are possible in the described embodiments, and other embodiments are possible, within the scope of the claims.

What is claimed is:

1. A circuit, comprising:
a current sense circuit having a sense input and a sense output, in which the sense input is coupled to an input terminal;
a comparator having a first comparator input, a second comparator input, and a comparator output, in which the first comparator input is coupled to the sense output, the second comparator input is coupled to a threshold terminal, and the comparator output is coupled to a fuse terminal;
a current programming circuit having a current input and a current output, in which the current input is coupled to the sense output;
a first circuit coupled between the sense output and a ground terminal; and
a second circuit coupled between the current output and the ground terminal.

2. The circuit of claim 1, wherein the current sense circuit comprises:
a sense resistor coupled in a power path between a power supply and a load;
an amplifier including amplifier inputs and an amplifier output, in which the amplifier inputs are coupled across the sense resistor; and
a multiplier circuit coupled between the amplifier output and the sense output,
wherein the amplifier is configured to provide a current signal representative of a current sensed in the power path, and
wherein the multiplier circuit is configured to provide a first current signal at the sense output that is proportional to a square of the current signal.

3. The circuit of claim 2, wherein:
the second circuit comprises a resistance element,
the current programming circuit is configured to provide a second current signal at the current input, in which the second current signal is representative of a square of a nominal current for a simulated fuse, and
the resistance element has a resistance, in which the resistance and a reference signal are configured to set a value representative of the square of the nominal current.

4. The circuit of claim 3, wherein the first circuit comprises a capacitor, and the capacitor has a capacitance configured to set a value representative of an I²t rating of the simulated fuse based on the first current signal and the second current signal.

5. The circuit of claim 2, wherein the amplifier is a first amplifier, the amplifier inputs include first and second amplifier inputs, the amplifier output is a first amplifier output, and the current programming circuit comprises:
a transistor having a first current terminal, a second current terminal, and a control terminal, in which the first current terminal is coupled to the sense output, and the second circuit is coupled between the second current terminal and the ground terminal; and
a second amplifier having third and fourth amplifier inputs and a second amplifier output, in which the third amplifier input is coupled to a voltage reference terminal, the fourth amplifier input is coupled to the second current terminal, and the second amplifier output is coupled to the control terminal.

6. The circuit of claim 1, further comprising a regulator circuit including a regulator output coupled to the sense output, in which the regulator circuit is configured to provide a regulated voltage at the sense output.

7. The circuit of claim 6, wherein the first circuit comprises a capacitor and the regulator circuit further comprises a current source having an output coupled to the sense output, in which the current source is configured to provide current to facilitate charging the capacitor.

8. The circuit of claim 7, further comprising a reset circuit comprising:
a reset comparator including first and second reset inputs and a reset output, in which the first reset input is coupled to the sense output, and the second reset input is coupled to a threshold voltage terminal; and
a switch coupled between the sense output and the ground terminal, in which the reset comparator is configured to control the switch to discharge the capacitor based on a voltage at the sense output and a threshold voltage.

9. The circuit of claim 8, wherein the switch and current source are controlled in a complementary manner based on the voltage at the sense output, in which the switch is configured to discharge the capacitor and the current source is configured to charge the capacitor.

10. A circuit, comprising:
a current sense circuit configured to provide a first current signal representative of a square of a load current;
a nominal current programming circuit configured to provide a second current signal representative of a square of a nominal current for a simulated fuse, in which the current programming circuit is configured to set the square of the nominal current;
a time-current circuit configured to provide a voltage based on the first current signal and the second current signal, in which the time-current circuit has an electrical characteristic representative of a current squared times time (I²t) rating for the simulated fuse based on the first current signal and the second current signal; and
a comparator configured to provide a comparator output signal, defining a fault condition, based on a voltage across the time-current circuit relative to a threshold voltage.

11. The circuit of claim 10, wherein the time-current circuit comprises a capacitor coupled between an output of the current sense circuit and a ground terminal, in which the voltage is provided across the capacitor based on the first current signal and the second current signal.

12. The circuit of claim 11, wherein the voltage is a first voltage, and the nominal current programming circuit comprises:
a voltage-to-current circuit configured to provide the second current signal based a second voltage at a voltage terminal; and
a resistance element coupled between the voltage terminal and the ground terminal, in which the voltage-to-current circuit is configured to regulate the second voltage at the voltage terminal based on the second current signal.

13. The circuit of claim 12, further comprising an integrated circuit that includes the nominal current programming circuit, the time-current circuit, the comparator, and at least one of the capacitor and the resistance element, in which the at least one of the capacitor and the resistance element is programmable.

14. The circuit of claim 12, further comprising an integrated circuit that includes the nominal current programming circuit, the time-current circuit, and the comparator, in which the capacitor is one of external or internal to the integrated circuit, and the resistance element is located one of external or internal to the integrated circuit.

15. The circuit of claim 11, further comprising a regulator circuit configured to provide a regulated voltage to the output of current sense circuit.

16. The circuit of claim 11, further comprising a current source configured to provide a third current signal to charge the capacitor based on a voltage at the output of current sense circuit.

17. The circuit of claim 16, further comprising a reset circuit comprising:
a switch coupled between the output of the current sense circuit and ground; and
a reset comparator configured to provide a reset signal responsive to a voltage at the output of the current sense circuit and a reset threshold voltage, in which the reset threshold voltage is less than the regulated voltage, and the switch configured to discharge the capacitor responsive to the reset signal.

18. The circuit of claim 10, further comprising a transistor configured to provide an open circuit condition in a current path of the load current responsive to the comparator output signal.

19. A system, comprising:
a switch, defining a fuse, including a first current terminal, a second current terminal, and a control terminal, in which the first current terminal is coupled to a supply voltage terminal, and the second current terminal is coupled to a load terminal, and the supply voltage terminal and the load terminal are in a power path;
a fuse control circuit, comprising:
a current sense circuit including a sense input and a sense output, in which the sense input is coupled to one of the first current terminal or the second current terminal;
a multiplier circuit including a multiplier input and a multiplier output, in which the multiplier input is coupled to the sense output;
a comparator circuit including a first comparator input, a second comparator input, and a comparator output, in which the first comparator input is coupled to the multiplier output, the second comparator input is coupled to a threshold terminal, and the comparator output is coupled to the control terminal of the switch;
a current programming circuit including a current input and a current output, in which the current input is coupled to the multiplier output; and
a capacitor coupled between the multiplier output and a ground terminal.

20. The system of claim 19, wherein:
the current sense circuit is configured to provide a current sense signal at the sense output, in which the current sense signal is representative of a load current through the power path,
the multiplier circuit is configured to provide a first current signal at the multiplier output based on the current sense signal, in which the first current signal is proportional to a square of the load current,
the current programming circuit includes a resistance element coupled between the current output and the ground terminal, the current programming circuit is configured to provide a second current signal at the multiplier output, in which the second current signal is representative of a square of a nominal current for a simulated fuse, and the current programming circuit is configured to set the square of the nominal current based on the resistance element, and
the capacitor is configured to set a value representative of current squared times time for the simulated fuse based on the first current signal and the second current signal.
